(19) United States
(12) Patent Application Publication
(10) Pub. No.: US 2003/0208400 A1
(43) Pub. Date: Nov. 6, 2003

(54) Incentive mechanism for encouraging adoption and use

(76) Inventors: Jeff Kuo, Hillside, NJ (US); Patrick J. Kenary, Chicago, IL (US)

Correspondence Address: PENNIE AND EDMONDS, 1155 AVENUE OF THE AMERICAS, NEW YORK, NY, 100362711

(21) Appl. No.: 10/239,999

(22) PCT Filed: Apr. 25, 2001
(86) PCT No.: PCT/US01/13367

(51) Int. Cl. G06F 17/60

(52) U.S. Cl. 705/14

(57) ABSTRACT

An incentive mechanism for encouraging the adoption and use of a communally useful entity. Use of the communally useful entity is tracked. An incentive payment to be paid by an incentive provider to a recipient is calculated, the recipient being the designee of a user of the communally useful entity, and the incentive payment proportionate to a measure of the user's use of the communally useful entity. The incentive provider is directed to distribute the incentive payment to the recipient, and an amount of rights to participation in the communally useful entity is distributed to the incentive provider's designee, where the amount of rights to participation distributed is proportionate to the value of the incentive payment made by the incentive provider. Thus, the user is given an incentive to use the transaction platform, and the incentive provider is given an incentive to encourage others use of the transaction platform. A software program and computer-based system are also disclosed.

### RELATED APPLICATIONS

This application claims priority to U.S. Provisional Application Serial No. 60/214,277, filed Jun. 28, 2000.

### FIELD OF THE INVENTION

The present invention relates to the provision of communally useful entities (C.U.E.'s) in a market environment. More particularly, the present invention relates to a financing mechanism for providing incentives to use a C.U.E.

### BACKGROUND OF THE INVENTION

Innovations are extremely important to a society. Whether new products, new services, or just new ways to do the same old things, innovations have been the primary means for advancement and betterment. Unfortunately, the novelty of innovations also makes them very risky and difficult to implement and apply. No one ever quite knows how a new product will be received; habits can be stubborn; old ways of doing things may have hidden value; or people can be just plain fickle. In fact, one of the primary goals of the field of diffusion research, an area of economics and sociology, is to study and explain why the application of innovations in a society is so slow, difficult, and unpredictable (Everett M. Rogers, The Diffusion of Innovations (New York: The Free Press, 1995)). It is one thing to come up with an invention; it is entirely another challenge to make it an innovation that adds value to a society.

The problem posed by diffusion is often a daunting challenge for an innovator, whether a business or not-for-profit effort. The prospect of a long, expensive, risky effort to spread the word about an innovation is often enough to discourage even enthusiastic innovators. Sadly, while our free-market system has spawned so much creativity, it lacks effective and efficient tools to promote the diffusion of innovations. The present invention provides a mechanism to address this problem. The mechanism speeds up and enhances diffusion while reducing its risks, with the end result being greater value, achieved faster, for the whole society.

Innovation in the Free Market

Standard market-based forces usually work well to fulfill society's needs. Businesses succeed because they are good at identifying and satisfying consumer demands, many times creating new products to fulfill existing demand in new ways. Driven by the forces of capitalism (or, for non-profits, charitable and social forces), businesses will develop needed products and ensure they are marketed and sold (diffused) as widely as possible. Businesses take these risks and incur the expense of providing these goods because, if their judgments are correct and their efforts successful, they arc compensated with profits. In this way, the free-market matches supply with demand.

Problems with the Free Market

Nevertheless, there are obstacles in the free-market system. Even for the typical business described above, the risks of diffusion are daunting. It is a grueling process to raise awareness and persuade people to use any product, and there are no guarantees of success. Even for breakthrough innovations, this process has historically taken far longer than anticipated (Paul A. David, “The Dynamo and the Computer: An Historical Perspective on the Modern Productivity Paradox,” AEA Papers and Proceedings, May 1990). Typically, new companies, with traditional products to offer, must compete by advertising and raising awareness about their advantages and why consumers should buy from them. This process takes time and money, and it must succeed on a large enough scale to make the whole enterprise worthwhile. And this is the simple case.

There are many other situations where the competitive process is far less effective. For example, there are new innovations that are technologically possible but are so ahead of their time that their wide acceptance (diffusion) is uncertain. Because of the novelty of such products, developers may believe that the diffusion will either be unsuccessful or take so long and require so much effort that it will deplete available funds and invested resources. Potential developers hesitate to take on the combined costs of developing and diffusing these innovations, and the products are never brought forth. If the costs and risks of development and diffusion could be separated, and the uncertainty and difficulty of diffusion mitigated, the prospects for these new innovations would improve, and they would more likely be developed.

Certain market situations, namely those that are affected by the so-called network effect, are almost solely dependent on the diffusion process. In these specific circumstances, normal market forces are woefully inefficient, and there is a tremendous amount of delay and waste before value is created for society. The network effect (known in diffusion research as reciprocal interdependence (Rogers, p.315)) describes situations where the value of a product or service for any given user is dependent on the level of use by others. In fact, Robert Metcalfe, founder of 3Com, devised a formula describing the network effect, sometimes known as Metcalfe's law. His formula states, “The value of a network grows as the square of the number of users.” (Remarks at the University of Virginia, May 1996, taken from the Smithsonian Institution web-site).

The classic example is the telephone. A single telephone, absent any other telephones, is useless. As each new user gets a telephone (and all telephone users can communicate with more people), the value of everyone's telephone increases. The same effect is at work in transaction platforms (real locations like stock exchanges and retail malls, as well as online platforms), e-business systems, and sets of technological standards.

The network-effect creates special diffusion challenges and opportunities. Because much of the value of network-effect products and services comes from widespread usage, diffusion becomes a primary concern. The existence of critical mass in networks—a level of adoption beyond which future diffusion is self-sustaining (Rogers, p. 313)—means that once certain milestones are hit, customers and owners can realize outsized benefits. But achieving critical mass by convincing an initial group to use the products is difficult. In a free market, that first group has no incentive to begin using the innovation—a “chicken or the egg” dilemma.

Economists use the concept of externalities to understand this problem. Externalities are costs or benefits caused by production and use of a good or service that are not reflected in the price. For example when a driver purchases and bums gasoline, neither the price he is willing to pay nor the price the seller is willing to charge reflect the social cost of pollution from wellhead to tailpipe. These social costs of pollution are externalities. Similarly, in many networks, the price of joining does not reflect the benefit new users provide to the network, and these benefits are network externalities. Nobel laureate Ronald Coase has written extensively about externalities and concluded in his famous theorem that the most efficient way to allocate resources is to internalize externalities through property rights (R. H. Coase, “The Problem of Social Cost”, The Journal of Law and Economics, Vol. III October 1960, (Chicago: University of Chicago Press)). By this he means that if ownership could be established for what are traditionally external costs and benefits, these costs and benefits could be reflected in privately-negotiated prices and in resource allocation. For example, if there is a single owner of a network, that owner can internalize the network benefits and allocate them to customers through subsidies and other pricing strategies. (Single ownership raises other issues, however, as customers must confront the owner's monopoly power.)

In addition, network goods and services often derive and provide maximum value when they are standardized. With the telephone system again, the new telephones can only add value to the network if the telephones operate in accordance with a single standard. Otherwise, additional telephones that cannot call each other are of no benefit for the system. To achieve the network-effect, a single standard is often necessary.

Conventional market competition is extremely ineffective in developing such unitary standards. Typically, during the early stages of a new industry, competitive forces give birth to a flood of efforts to become the sole standard. The result is a cacophony of multiple initiatives, each claiming superiority. Unfortunately, unlike typical products where variety is usually desirable, multiple, competing standards impose costs, not benefits, on users. (With the telephone, multiple telephone systems would force users to either buy multiple, incompatible telephones or forego connection with those on different systems.) Until the evolutionary process of selection and attrition is complete, users are left with devices or services that are far less valuable than they could be under a single system. (A classic example of this process is the ATM machine. (Adam M. Brandenberger and Barry J. Nalebuff, Co-opetition, (New York: Doubleday, 1996)) Establishing a standard through conventional competitive processes is therefore wasteful. It provides no benefit to users; it adds risks for the product providers; and it delays the efficiency a single standard provides.

In recent years, the need for new diffusion tools to address these problems has been particularly acute. Many current innovations, especially those spawned by the growing popularity of the Internet, have been both startlingly innovative and particularly suitable for the benefits of the network effect. But most of these products and ideas (for example, e-business platforms) face tremendous commercialization hurdles precisely because they are new and valuable only if they can take advantage of the network effect. Diffusion of such products is extremely difficult and may take decades.

Attempts at Solutions

Societies have used various strategies to supplement free-market processes and promote the diffusion of innovations. In some cases, government has tried to fulfill the needs directly: funding standardization efforts such as the conversion to the metric system, funding research on projects with challenging commercial prospects, even directly running operations such as the US Mail system (a network-effect service). However, in recent years, there has been more recognition of the costs and negative effects of government control of innovations and other resources, and societies have looked for privately-directed solutions (James Buchanan, Liberty, Market, and State, (New York: New York University Press, 1986) p. 22, Paul David, The Hero and the Herd, in Favorites of Fortune, eds. Higonet, Landes, and Rosovsky, (Cambridge: Harvard University Press, 1991, note 17)).

Absent a government-directed solution, members of an industry or group will sometimes join together in a consortium to develop an innovation for their collective benefit. In this way, individual members hope to use the coercive effect of their combined clout in the marketplace as a means to advance diffusion of an innovation. This approach is an attempt to overcome the barriers to voluntary collective action by giving members a financial interest (ownership) in the consortium. In the area of network-effect entities, consortia hope collective ownership will promote diffusion and bypass the standard-setting process by allowing the imposition of a single standard on an entire industry. (This is a popular approach for creating electronic exchanges—COVISINT™ in the automobile industry, TRANSORA™ in the packaged goods industry, and MYAIRCRAFT.COM™ in the aerospace industry.)

Despite these intentions, the consortium approach has significant problems. First, consortia facilitate anti-competitive, collusive behavior as competitors in an industry engage in significant commercial agreements. Anti-trust law—intended to prevent this behavior—imposes significant burdens on consortia. Second, consortia are extremely difficult to manage, since the members of the consortia, who are typically competitors, must suppress their rivalries and co-exist. Third, market participants who were not invited or did not join the consortium often form alternative associations—often motivated by the desire to balance the scales of power within the industry. This banding together (against the consortium) can occur among other competitors (those that were not included), among suppliers to the members of the consortium, or even among consortium members' customers.

Fourth, and more importantly, the consortium approach does not actually address the diffusion challenges in free-market structures. Members are not individually motivated to drive diffusion of an innovation just because of common ownership. The costs of driving diffusion are borne individually, but the benefits are spread among all of the members, regardless of their contribution. This sharing without regard to contribution creates what are known as “free-rider” problems because rational members of the group will try to receive the benefits for free without contributing to their production. Naturally, the benefits (here, diffusion) rarely materialize. Without additional incentives, coercive measures or complicated membership agreements, individual members of a consortium rarely will act for the collective benefit Mancur Olson, The logic of Collective Action, (Cambridge: President and Fellows of Harvard College, 1965, 1971)). Without collective action, a consortium is in a worse position than other innovators. It still must bear the substantial costs and risks of diffusion of its innovations, but it can be crippled by inaction.

Finally, even if a consortium manages to both avoid legal sanction and somehow enforce cooperation, it is prone do more harm than good—to its members, its industry, and the wider society. The collusive behavior of consortia will likely arouse suspicion and worse among suppliers and customers. If the consortium wants to do anything that involves these partners (such as operate an e-business platform to transact business with them), it is unlikely under these circumstances. In fact, the ill will the consortium generates will more probably damage ongoing relationships with these essential partners, hurting the entire industry.

In the absence of government direction and attempts to force large-scale cooperation, the final option is the ordinary free-market process—raise and spend large sums of money to both create a product and gain broad adoption for it. This default course of events is what occurs in most cases and in most industries. Although, the end results may be achieved, the process is very slow (usually taking decades) and is very wasteful. In addition, because of these obstacles, our society has likely foregone the benefits of many valuable products and services, as successive failures have led to a complete abandoning of any further attempts to commercialize.

A Better Way

Because of these obstacles and difficulties, it would be highly beneficial to advance the development of new products, services, standards, and other goods—especially goods susceptible to the network effect—with a mechanism that includes the following characteristics:

1) Market-based

2) Facilitates diffusion of innovations

3) Diminishes risk

4) Facilitates special diffusion needs of innovations with network effects

5) Avoids anti-competitive activity

6) Simple and easily deployable

### SUMMARY OF THE INVENTION

The present invention relates to a mechanism to offer to certain parties or their designees equity ownership or other rights to participation in a communally useful entity (“C.U.E.”) in exchange for those parties' payments of incentives to the C.U.E.'s users or their designees (“recipients”). The incentive payments are in turn made in proportion to a measure of a recipient's use of the C.U.E. Measures of use may include the value of users' transactions on a transaction platform, quotes posted or quotes received on a request-for-quote service, volume, weight, or distance in a transportation or shipping system, time or volume of communications in a communication system, agreement to use standards or protocols, membership in a standard or protocol setting organization, proportion of capacity in any system, or any other agreed upon measure.

Herein, the term “communally useful entity,” refers to any entity that provides value to a community or to some members of a community. Because the invention is most beneficial to entities strongly influenced by the network effect, C.U.E.'s, for the purposes of the invention, will typically be network-effect entities, meaning entities whose usefulness to every user is incrementally increased with the addition of each new user. Such entities would include sets of standards, specifications, or protocols, organizations that create and/or maintain sets of standards, specifications, or protocols, transaction platforms, money or credit systems, transportation systems, languages (person-to-person or computer software), and communications systems.

In addition, the invention can be usefully applied to entities that are not obviously influenced by the network-effect. Consequently, C.U.E.'s may also be any project, such as a business, good, service, public-works project, or organization that requires a minimum of diffusion to survive and provide value to the community. For the purposes of the invention, C.U.E.'s are entities capable of being privately owned or capable of distributing rights to participation in themselves, their assets, or their income.

Herein, “transaction platform” refers to any centralized location (real or on-line), or any other mechanism or entity whose main function is to facilitate the exchange of goods, services, or information among participants (such as buyers and sellers). Examples of transaction platforms would be: e-business platforms, retail malls (actual real property or on-line), auction sites (real property or online), securities or commodity exchanges (real property or online), convention halls, industrial parks, or any other similar entity.

The term “e-business platform” refers to a communications system, distributed or centralized, that is accessible to participants (such as buyers and sellers) and provides a means to communicate and process electronic representations of business information and/or transactions via computers located with the participants or a third party.

This mechanism creates several interlocking tendencies that together support the success of the C.U.E. Not only are potential users encouraged to use the entity and incentive providers encouraged to pay incentives, but neither bears the typical risk involved in a new entity, and there is no immediate cost to the entity for these incentives.

In addition, incentive providers with a special interest in the success of the C.U.E. can add another layer of support. For example, if the invention were intended to drive adoption of an e-business platform where an entire industry could benefit from its development, leading industry participants would be ideal incentive providers. They would have an interest in supporting the C.U.E. because they could benefit both from the platform services and the financial success of the platform as a business. They would also be in a position to influence the behavior of others in the industry.

Essentially, the invention takes the future value of a C.U.E. (equity, etc.) and distributes it in ways that encourage actions today that will enhance the size of, and likelihood of realizing, that future value. In this way, it effectively internalizes the network externalities by allocating the network-effect benefits to those who create them At the same time, concern about monopoly capture of these benefits is mitigated because the owners of the network will be customers and commercial partners of customers. The method of distribution also makes the mechanism extremely adaptive—responding to the ebbs and flows of adoption and diffusion. There will always be surprises and disappointments so adaptation is essential to manage the risk this uncertainty presents.

Although the invention is most effective when applied to interactive institutions with strong network effects, like transaction platforms, standards, protocols, and specifications, retail malls, and communication systems, the invention could promote virtually any business or project, regardless of its susceptibility to network effects. All significant projects can benefit from better diffusion, and the invention facilitates this diffusion in a competitive, free-market environment.

In a specific embodiment, the invention comprises the steps of: tracking and measuring the use of a C.U.E.; calculating an incentive payment to be made to a recipient who is a user or a user's designee, the payment made by another party (the “incentive provider” or “payer” who may or may not be a user of the C.U.E.), and paid in proportion to a measure of use of the C.U.E.; directing the distribution of the incentive payment from the incentive provider to the recipient; distributing an amount of rights to participation in the C.U.E. (or another entity with a financial and/or control interest in the C.U.E.) to the incentive provider or the incentive provider's designee, the amount of rights to participation distributed proportionate to the incentive payment made. In this method, both the incentive provider and the user derive benefits in addition to value they perceive in the C.U.E.

In an alternative embodiment, the recipient of the incentive payment is given the option to refuse the incentive payment and instead receive the rights to participation in the C.U.E. that would otherwise go to the incentive provider.

In another alternative embodiment, if the recipient opts to receive the rights to participation in the C.U.E., rather than receive the incentive payment, the incentive provider can pay the incentive payment directly to the entity that distributes the rights to participation in the C.U.E. and in return receive an equivalent amount of rights to participation in the C.U.E.

In a preferred aspect, the financial value of the C.U.E., or any entity that holds a financial and/or control interest in the C.U.E., is related to the adoption and utilization of the C.U.E. In one variation, the C.U.E. may include an electronic transaction interface, which may be implemented on a web-site accessible via the Internet. In other variations, the C.U.E. may be a physical location for the conduct of trade (e.g., a retail mall or a securities or commodities exchange), a communications system (voice, data, video), a set of standards or protocols, a public works project, or any other business or similar entity. The incentive payment may take the form of cash, a credit toward future transactions (e.g., future purchases of goods or services), or any other tangible form that provides an economic benefit to the recipient. Alternatively, the value of the incentive payment may be related to the overall level of utilization of the C.U.E. among all industry participants.

In another embodiment, the present invention relates to a software program implemented on a computer for encouraging the development of a C.U.E. The software program configures the computer to: track the use of the C.U.E.; calculate an incentive payment to be paid to a recipient who is a user or a designee of a user of the C.U.E.; direct the distribution of the incentive payment from the incentive provider to the recipient; and direct distribution of an amount of equity ownership or other participation in the C.U.E., or any entity with a financial and/or control interest in the C.U.E., to the incentive provider or the incentive provider's designee, the amount of equity ownership or other participation distributed proportionate to the incentive payment made; whereby both the incentive provider and the user are given an incentive to use or encourage use of the C.U.E. As above, the incentive payment may take the form of cash, a credit toward future transactions (e.g., purchases of goods or services), or any other tangible form that provides an economic benefit to the recipient.

In still yet another embodiment, the present invention relates to a computer-based system for encouraging the development of a communally useful entity. The system comprises a processor, a computer executable routine programming the processor to: (a) track a measure of use of the communally useful entity, (b) calculate an incentive payment to be paid by an incentive provider to a recipient, the recipient being the designee of a user of the communally useful entity, and the incentive payment proportionate to the measure of the user's user of the communally entity, and (c) calculate an amount of rights to participation in the communally useful entity for distribution to the incentive provider's designee, the amount of rights to participation distributed proportionate to the value of the incentive payment made by the incentive provider; and a storage for storing data relating to: a measure of use of the communally useful entity by one or more users, incentive payments made by one or more incentive providers, incentive payments received by one or more recipients, and rights to participation distributed to one or more incentive providers' designees whereby the user is given an immediate incentive to use the communally useful entity, and the incentive provider is given a long-term incentive to encourage others' use of the communally useful entity. The computer executable routine may further program the processor to track whether the user's designee accepts or declines of the incentive payment.

### BRIEF DESCRIPTION OF THE DRAWINGS

The present invention will be understood and appreciated more fully from the following detailed description, taken in conjunction with the drawings in which:

FIG. 1 is a flowchart illustrating the steps in a preferred embodiment of the method of the present invention;

FIG. 2A is a flowchart illustrating the steps in another preferred embodiment of the method of the present invention;

FIG. 2B is a continuation of the flowchart of FIG. 2A, illustrating additional steps in a preferred embodiment of the method of the present invention;

FIG. 3 is a flowchart illustrating the steps in still another preferred embodiment of the method of the present invention;

FIG. 4A is a block diagram illustrating the operation of an incentive mechanism in a preferred embodiment of the present invention;

FIG. 4B is a block diagram illustrating a variation of the incentive mechanism shown in FIG. 4A;

FIG. 5A is a block diagram illustrating the operation of an incentive mechanism in another preferred embodiment of the present invention;

FIG. 5B is a block diagram illustrating a variation of the incentive mechanism shown in FIG. 5A;

FIG. 6 is a block diagram illustrating the operation of an incentive mechanism in still another preferred embodiment of the present invention; and

FIG. 7 is a schematic block diagram illustrating a computer system that may be used in implementing the present invention.

### DETAILED DESCRIPTION OF THE PREFERRED EMBODIMENTS

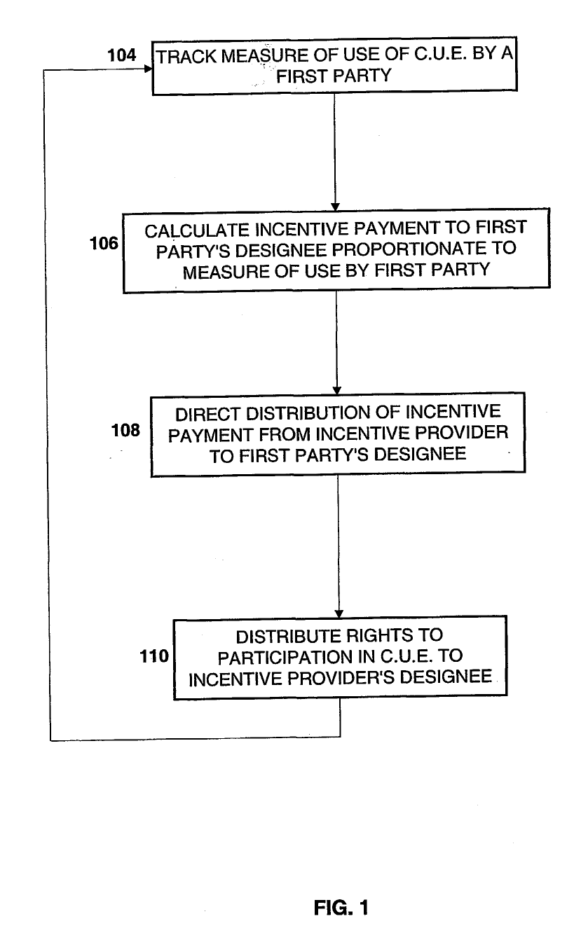

Reference is now made to FIG. 1, which is a flowchart illustrating the steps in a preferred embodiment of the present invention. In step 104, use of the C.U.E. is measured, tracked, and recorded. Measures of use may include value of transactions, time in use, number or value of quotes requested or quotes given, unit volumes exchanged, individual uses of the platform, size, weight, or distance of products transported, proportion of capacity used, or any other agreed upon measure. Tracking and recording of use may be performed by a software program running on a computer. In step 106, an incentive payment for the use of the C.U.E. is calculated. Herein an “incentive payment” or “rebate” is a payment to a party that uses a C.U.E., the incentive payment proportionate to the amount of an agreed upon measure of use of the C.U.E, either by the individual user, or as a share of the total use by all users. The incentive payment may take the form of a cash amount, a credit toward future purchase transactions, additional goods, or any other tangible form that provides an economic benefit to the recipient.

In step 108 an incentive provider is directed to make the incentive payment calculated in step 106 to the designee of a user of the C.U.E. (the designee may be the user itself) (“recipient” or “recipients”). The “incentive provider” is any entity, whether a user of the C.U.E. or not, that makes incentive payments to parties using the C.U.E. In order to make the incentive payments, the C.U.E., or a business entity associated with the C.U.E., may transfer finds or credits directly from the incentive provider's account to the recipient's account, or, in the alternative, the incentive provider may arrange for the incentive payment to be distributed directly to the recipient independent of the C.U.E. Various other payment arrangements may also be used. In step 110, upon distribution of the incentive payment, the C.U.E., or a business entity associated with the C.U.E., transfers to the incentive provider's designee (the designee may be the incentive provider itself) an agreed upon amount of rights to participation in the C.U.E., those rights to participation proportionate to the value of the incentive payment made in step 108. The rights to participation may include equity ownership, such as common stock or any other divisible means of ownership, a preferred stock or credit instrument representing a portion of revenues or profits, or some other financial interest, control rights, such as voting rights or board seats, liquidation rights or any other rights in either the C.U.E. or a business entity that has a financial and/or control interest in the C.U.E. Herein a “business entity” is a corporation, partnership or other entity with equity or some other form of divisible ownership or rights to participation. Herein, a “financial and/or control interest” is some claim, whether direct or indirect, to the income, profits, revenue, or other assets of an entity and/or rights to participate in the governance of an entity. The process then returns to step 104 and steps 104 through 110 are repeated indefinitely.

As a result of this arrangement, the effective diffusion of innovations is promoted in a free-market system.

Diffusion is most explicitly aided by this arrangement through the incentives themselves. Those receiving the incentive payments—the recipients—are users themselves or designees of users of the C.U.E. In this way, the users, in addition to their ordinary desire to use the C.U.E., will be further encouraged to use the C.U.E. and in some circumstances to influence others to participate with them in using the C.U.E. Similarly, those contributing the incentive payments (incentive providers), by virtue of the financial and/or control interest they or their designees accrue in the C.U.E.'s success, will have an additional interest in encouraging others to use the C.U.E., beyond whatever value they already perceive in promoting the use of the C.U.E. In sum, the potential users of the C.U.E. have an immediate, additional incentive to use the C.U.E., and the incentive providers have an additional incentive to encourage use of the C.U.E.

These additional incentives act as drivers of the diffusion process. Diffusion research has shown that there are often wide cultural, educational and communication chasms between pioneering early users and more traditional members of the wider group (Geoffrey Moore, Crossing the Chasm, (New York: Harper Collins Publishers, 1991, 1999), Rogers). The research also shows that one of the most effective ways to bridge this gap is with clear, explicit incentives to encourage more traditional members of a group to adopt an innovation and to encourage advocates of adoption (Olson, p. 51, Moore, Rogers). The incentives in this arrangement fill this role.

Just as important, but perhaps less obvious, are the ways the present invention lowers the total risk related to innovations (not just the diffusion risk). By apportioning the specific risks that make up the overall risk associated with an innovation to those that are best suited to shoulder them, the present invention increases the overall probability of success of the innovation by taking advantage of every participant's comparative advantage.

For example, in most situations, value is created by an innovation through the completion of two steps. The first step usually involves initiating the C.U.E.—developing and providing something new like a product, service, or organization. The risk associated with this step can be considered the operational risk. The second step then involves taking the results of the first, and providing it to the marketplace—a diffusion process. The risk associated with this step can be considered the diffusion risk.

The present invention effectively separates each of the above described risks, the operational risk and the diffusion risk, and then apportions each to those most suited to bear them. Continuing with the example, the operational risk can then be borne by entities that finance, develop, manufacture, or otherwise provide the C.U.E. The diffusion risk in turn can be borne by entities that pay incentive payments. Because the risks are thus separated, each risk can be allocated to entities that can most effectively bear and mitigate it.

As a more tangible example, e-business platform developers can finance the construction and completion of an e-business platform from willing sources that are experts in the necessary fields (the operational risks). At the same time, developers can effectively finance—through incentive payments—the reduction of adoption and marketing risks from sources that are potential users themselves or have commercial influence over them (the diffusion risks). Because the bearers of the risks are entities that can best bear and mitigate them, the overall risk for the e-business platform is reduced.

Furthermore, unlike traditional methods where businesses raise funds and spend them to encourage diffusion, the invention eliminates the time and the risk separating the allocation of the funds and the successful diffusion of the innovation. In the invention, the funds to drive diffusion are not appropriated from their sources until behaviors actually change and the use of the C.U.E. occurs. This harmony and link between the incentive expense and the actual use of the C.U.E. is extremely important because it reduces the financial risks for the incentive providers. Incentive providers are not required to commit resources until the diffusion uncertainty—time, cost, and overall success—has been greatly reduced. This reduction of risk is particularly valuable for more novel innovations that require changes of behavior. Diffusion and economic history research both have shown that these behavioral changes are notoriously unpredictable and usually take far longer than experts in the field of the innovation expect (Rogers, David).

In situations where entities are particularly suited to benefit from the network effect, the present invention is especially valuable. It encourages many individuals to act in concert—to promote and standardize the C.U.E.—without relying on unrealistic (or illegal) cooperation. Unlike the case with most consortia, incentive providers receive financial interest in the C.U.E. only when they encourage actual use of the entity. In consortia, ownership is typically doled out and finalized before anything else occurs, a static structure. If consortia do use incentives, they are typically non-adaptive mechanisms, like minimum volume commitments, that actually increase the risks the consortium members face.

In the present invention, financial interest is not distributed based on initial agreements to set up a C.U.E., nor based on investments of money. Rather, it is dynamically distributed based on encouraging and attaining actual use of the C.U.E. by its participants. This connection eliminates the free-rider problem, where consortium members might try to receive the financial benefits of the entity without contributing to its success (Olson, p. 58), but it does so without using coercion or extracting risky commitments or upfront investments. With the present invention, there is no way to passively receive any of the financial rights allocated. Instead any recipients of financial interests must actively support the C.U.E. and support it in the most crucial way—by promoting adoption and use.

By internalizing network externalities, the invention will also encourage the formation of critical mass. Increased use enhances the value of the C.U.E. to all users, in turn enhancing its business value to financial participants. The increasing value of the C.U.E. for users and the business value of the C.U.E. for incentive providers generate a virtuous circle that reinforces the entity's success. By speeding the formation of the critical mass, the mechanism of the invention lowers the cost of marketing the C.U.E. product.

Furthermore, because the incentives are separated, they can be structured and directed to have the greatest impact on the success of the C.U.E. Specifically, short-term incentives (incentive payments, such as cash payments or trade credits) can be directed to entities who demand short-term incentives and whose use of the C.U.E. is necessary in the short term. Similarly, long-term incentives (rights to participation) can be directed to entities who respond to long-term incentives and whose long-term support for the C.U.E. is necessary. In this way, the mechanism takes advantage of the inherent value of exchange by creating a mechanism for those who value short and long-term incentives differently to effectively exchange them.

Nevertheless, even though it promotes the generation of collective benefits for an industry, the invention avoids the anti-competitive aspects of consortia. Because the mechanism is self-executing, it does not require competitors to engage in substantive commercial agreements with each other. In fact, there is really no clear group with formal membership. The only condition of participation is action in support of the common benefit provided by the C.U.E.

This ease of participation also further aids in diffusion. Because the mechanism allocates rights to participation incrementally, as use takes place, those that want to take a financial interest in the supporting entity need only agree to make the incentive payments rather than make an upfront investment. This low cost of entry eliminates barriers to inclusion like investment requirements or minimum transaction volume commitments. Because the barriers to participation are so low, the rights to participation in the C.U.E. can spread broadly. This spread of financial interest widens the circle of entities that have an interest in promoting the C.U.E.'s success.

The present invention then has the following characteristics:

1) It is market-based

2) It directly facilitates the diffusion of innovations

3) It diminishes the risk in the diffusion process

4) It addresses the special diffusion needs of innovations with network effects

5) It avoids anti-competitive activity

6) It is simple and easy to deploy

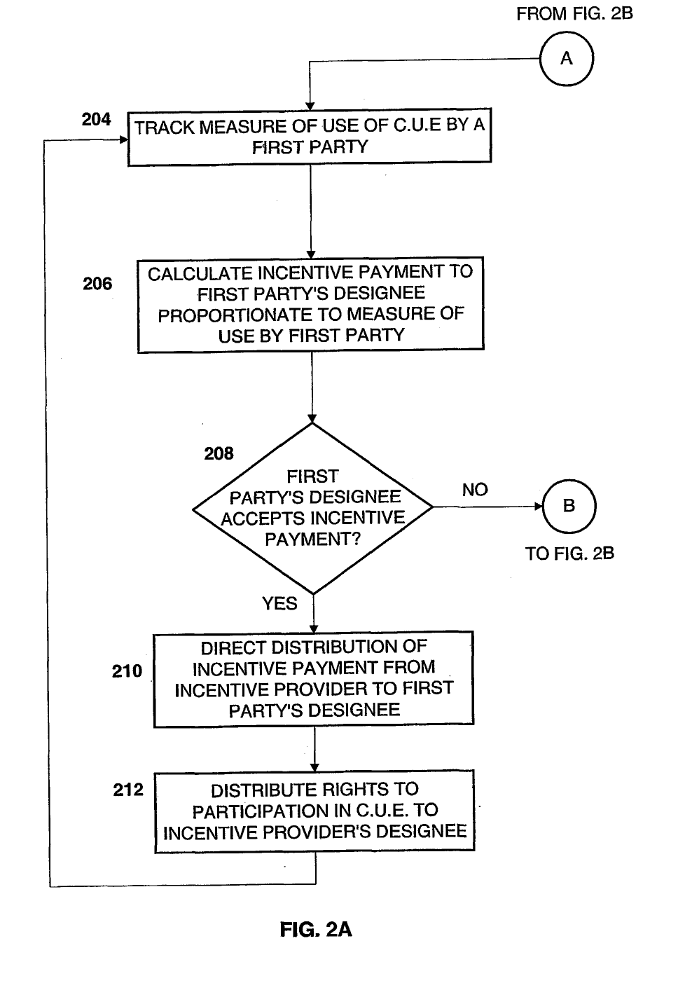

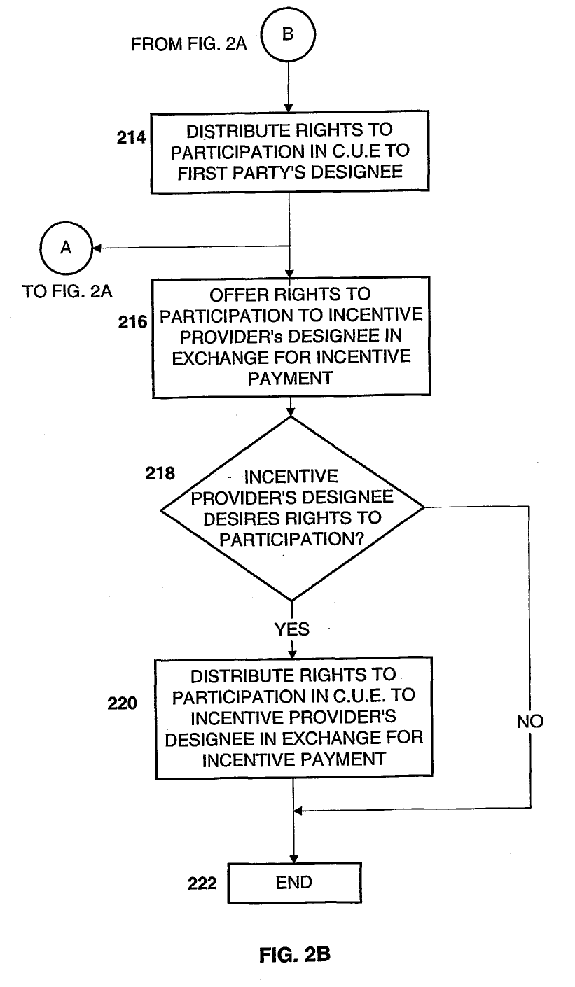

Reference is now made to FIGS. 2A and 2B, which illustrate the steps in another preferred embodiment of the present invention. In this embodiment, steps 204 through 206 are identical to steps 104 through 106 in FIG. 1. Use of the C.U.E. is measured (step 204); and an incentive payment is calculated based on the measure of use (step 206). However, in this embodiment, in step 208, the potential recipient(s) of incentive payments (users or their designees) are given the option, to be exercised immediately or over a period of time, to either accept or decline the incentive payment from the incentive provider. If the proposed recipient declines the incentive payment from the incentive provider, an amount of equity or other rights to participation in the C.U.E., proportionate or equivalent to the value of the proposed incentive payment, is distributed at step 214 to the proposed recipient of the incentive payment, rather than to the incentive provider or the incentive provider's designee. In other words, the recipient is given the option to take the incentive payment in the form offered by the incentive provider or in the form of the rights to participation in the C.U.E. that would otherwise go to the incentive provider (or the incentive provider's designee) in exchange for the incentive payment. In some cases, designated recipients may be provided with this option upon initial implementation of the incentive mechanism, or they could be provided with this option some time after the incentive mechanism has been implemented. Securities Exchange Commission regulations may initially prevent this option from being available to a large class of designated recipients. In addition, however, in step 216, the incentive provider may be offered the opportunity to purchase, for itself or its designee, rights to participation in the C.U.E. in exchange for paying the incentive payment directly to the C.U.E. or to the entity that distributes rights to participation in the C.U.E. In other words, both the designated recipient and the incentive provider are given the option to exchange the incentive payment for rights to participation in the C.U.E. In step 218, if the incentive provider desires to make this exchange, the rights to participation in the C.U.E. are distributed to the incentive provider's designee in step 220, and this branch of the process ends in step 222. Otherwise, if the incentive provider does not wish to pay an incentive payment directly to the C.U.E. or to the entity promoting the platform in exchange for rights, this branch of the process jumps from step 218 and ends in step 222.

Returning to step 208, if the proposed recipient accepts the incentive payment from the incentive provider, this recipient receives the incentive payment in step 210. In step 212, the incentive provider's designee receives an amount of equity ownership or other rights to participation in the C.U.E. proportionate to the value of the incentive payment contributed to the designated recipient. The process returns to step 204 and steps 204 through 222 are repeated as necessary.

As a result of this arrangement, in addition to the benefits described in the previous embodiment, the value of the incentive payment is enhanced for the recipients because of the value of a choice (whether to receive the incentive payment or to receive the rights to participation), similar to the value in stock option premiums. At the same time, the cash or other contribution made by the payer is not increased and is likely diminished. In fact, because the value of the rights to participation in the C.U.E. will increase in relation to the use of the C.U.E., this option will serve as an effective cap on the total amount of incentive payments contributed by the incentive providers. One would expect this pattern to occur because proposed recipients should tend to exercise this option more frequently as they perceive the value of the C.U.E. increasing. This perception of increased value will in turn coincide with increases in the use of the C.U.E. Consequently, the payers of the incentive payments will be spared the contributions that they would otherwise have to make as the amount of those contributions increased.

In addition, this arrangement also provides ownership opportunities in the C.U.E. to a wider range of entities, increasing the base of natural support for the C.U.E. and counteracting any over-concentration of ownership among one group of entities with narrow commercial interests. For example, if manufacturers in an industry paid incentive payments to distributors and in return received rights to participation in an e-business platform, financial interest in the e-business platform would spread among manufacturers but not distributors. This situation could diminish important support for the e-business platform among distributors. In the arrangement in FIGS. 2A and 2B, however, the ownership in the e-business platform would spread to distributors as well, eliminating this problem.

Furthermore, as a result of the arrangement giving the incentive provider(s) an option to invest directly in the C.U.E., or a business entity associated with it, at a time when the C.U.E. is successfully generating use, the business entity can take advantage of an available source of financing, while maintaining the essential tie between the ability to invest and actual use of the C.U.E. Consequently, the financial interest in the C.U.E. spreads, and adoption is enhanced.

In all embodiments, the developers of the C.U.E.'s will want to decide who should be incentive providers, who should be recipients of incentive payments, and who should be given what options of what duration. These decisions will depend on the specific nature of the industry or community the C.U.E. will serve, the nature of the C.U.E., and the specific goals of the developers. In all cases, the fundamental mechanism—where users of the C.U.E. receive incentive payments tied to a measure of their use, and payers of incentive payments receive rights to participation remains.

For purposes of illustration, it will be helpful to describe specific preferred embodiments that are examples of the main embodiments above. There are numerous ways that the payment and/or receipt of rebates and/or rights to participation may occur through intermediaries designated by the incentive provider and the C.U.E. user. These arrangements may provide administrative, business, corporate governance, tax, accounting, risk or other benefits. Those skilled in the art will recognize, however, that while the number of potential embodiments of the invention involving intermediaries is virtually limitless, all of these embodiments would contain the same essential elements.

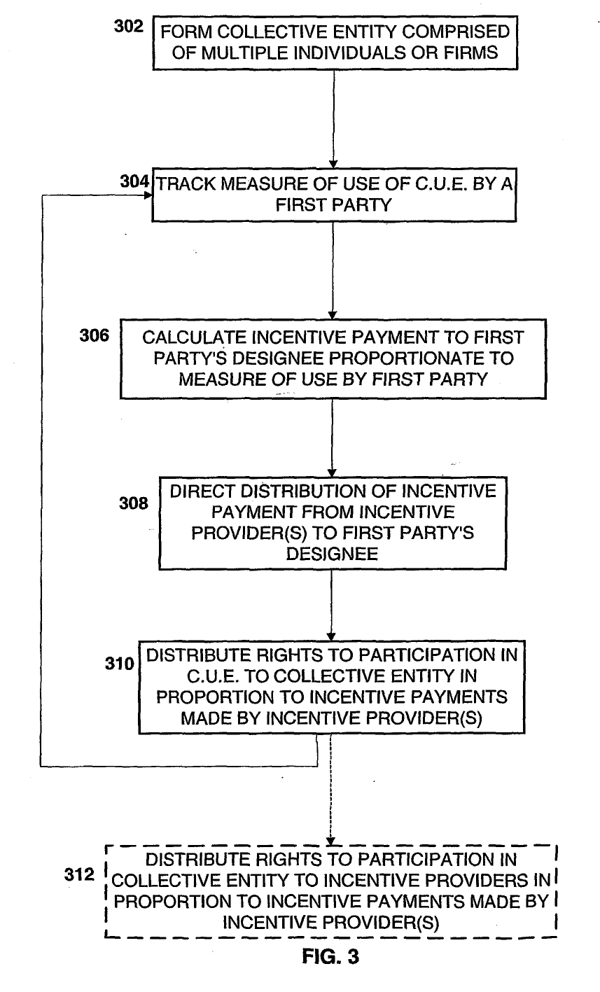

For example, one preferred embodiment employs the following steps. Reference is now made to FIG. 3. In step 302, an entity, such as a consortium, is formed in which multiple current or potential incentive providers have a financial interest (“collective entity”). In step 304, a measure of use of the C.U.E is tracked. In step 306, incentive payments to be made by incentive providers to recipients are calculated based on the measure of use of the C.U.E. by users. Recipients are users' designees (designees may be the users themselves). In step 308, incentive providers are directed to make incentive payments to a recipient, the recipient being the designee of a user of the C.U.E. and the incentive payment related to the measure of use of the C.U.E. by the user. In step 310, rights to participation in the C.U.E. or an entity with a financial and/or control interest in the C.U.E. are distributed to an entity designated by the incentive provider, in this case, the collective entity, the rights to participation distributed in proportion to the incentive payments made by the incentive provider. In this way, the collective entity may accumulate the rights to participation in the C.U.E. on behalf of multiple incentive providers. In a further refinement of this embodiment, in step 312, the collective entity may distribute equity or some other rights to participation in itself (the collective entity) to the individual incentive providers in relation to their incentive payments to users of the C.U.E. and to the rights to participation the collective entity receives in the C.U.E. in consequence of those payments.

The embodiment in FIG. 3 is but one of a great variety of structures that would employ intermediaries with the invention. Another preferred embodiment employs the following steps. The C.U.E. monitors the use of the C.U.E. A collective entity makes incentive payments on behalf of individuals or individual firms to users in proportion to the users' use of the C.U.E. In return for these incentive payments, rights to participation in the C.U.E. are distributed to the individual entities on whose behalf the incentive payments are made. In this arrangement, the incentive payments by the collective entity may be useful to provide administrative simplification for the application of the invention.

In still another embodiment using the following steps, both the payments and the accumulation of rights to participation may occur through an intermediary collective entity. The use of the C.U.E. is monitored. A collective entity makes incentive payments on behalf of individuals or firms to users' designees in proportion to the users' use of the C.U.E. In return for these incentive payments, rights to participation in the C.U.E. are distributed to the collective entity in proportion to the incentive payments made by the collective entity. The collective entity in turn distributes equity or some other rights to participation in itself (the collective entity) to individuals or firms in relation to incentive payments made on behalf of these firms or individuals, in relation to funds contributed by those firms or individuals for incentive payments to users of the C.U.E., and in relation to the rights to participation in the C.U.E. received by the collective entity in return for these incentive payments.

These embodiments above are merely specific examples of the main embodiment in FIG. 1 The details of these embodiments illustrate how incentive providers might make incentive payments and/or receive rights to participation indirectly through collective entities. Similarly, groups of current or potential users/recipients might also create and/or designate collective entities to receive the incentive payments or rights to participation on their behalf as well. In this vein, the refinements in FIG. 2 would also apply in these embodiments where users would have the option to receive the incentive payments or receive the equivalent rights to participation.

Those skilled in the art will see that the incentive mechanism can be used in a variety of circumstances and corporate or other structures that are not obviously similar to the examples described. The essential elements of the invention that allow parties to exchange incentive payments for rights to participation in a C.U.E. would remain.

In addition to the above embodiments, those skilled in the art will recognize that the incentive mechanism could be made available to businesses and other entities under a virtually infinite variety of financial arrangements. The mechanism could be licensed to companies or other entities for a fee, for a percent of the incentive payments, for a percent of the rights to participation in the C.U.E., for equity or other rights to participation in the incentive providers or users themselves. As shown above, incentive providers could make incentive payments directly to users who use selected communally useful entities, but the rights to participation in the C.U.E. could accumulate in a single separate entity. This entity could then distribute rights to participation in itself to incentive providers in proportion to their incentive payments. In all of these cases, the mechanism remains the same. One party (the incentive provider) makes incentive payments to the designees of users of a C.U.E. in order to promote the adoption and use of the C.U.E., and in return, that paying party's designee receives rights to participation in the C.U.E., either directly or indirectly.

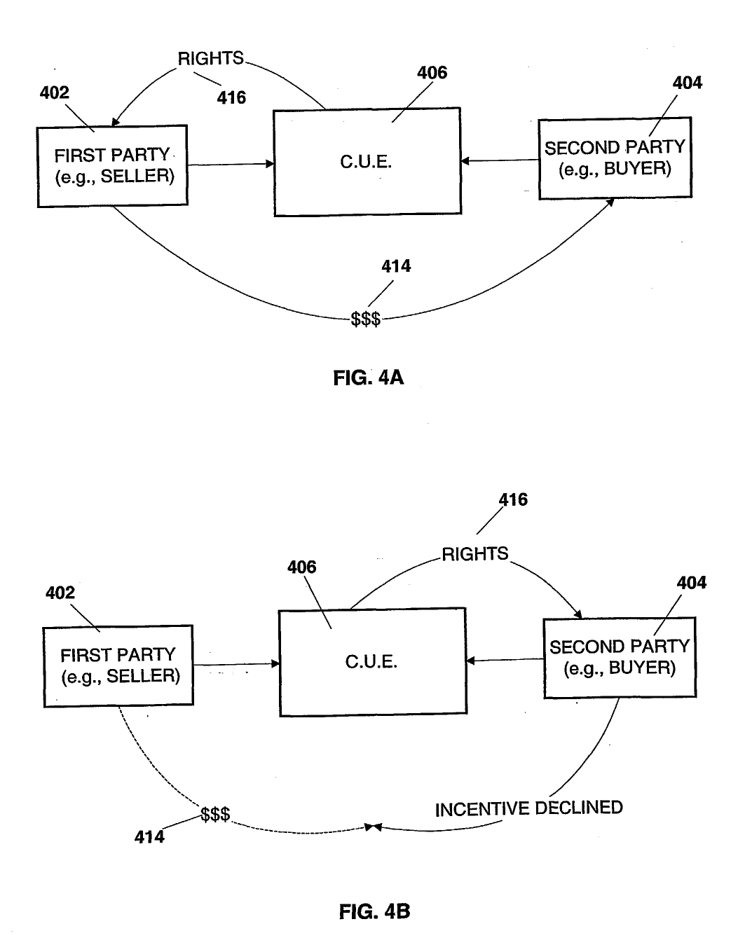

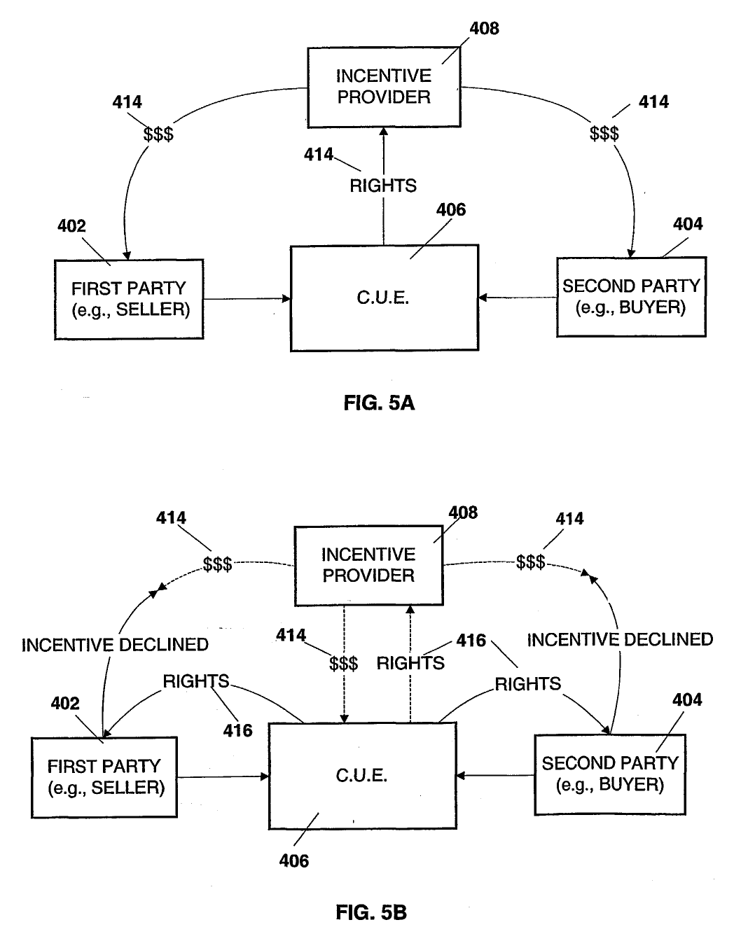

Reference is now made to FIG. 4A which is a block diagram illustrating the operation of a preferred embodiment of the incentive mechanism of the present invention. Sellers 402 and buyers 404 enter transactions using a C.U.E. that is a transaction platform 406. Buyers 404 purchase goods and services from sellers 402 using the C.U.E. 406. For a given transaction, an incentive payment 414 related to the value and/or amount of goods or services bought by a buyer 404 from a seller 402 via the C.U.E. 406 is calculated and paid to the buyer's designee (designee could be the buyer itself). In this embodiment, the incentive payment is contributed by a party to the transaction—(seller) 402. In alternate embodiments, the incentive payment may be provided by buyer 404 to seller's designee 402. In still other embodiments (shown in FIGS. 5A and 5B), the incentive payment is provided by a non-party to the transaction. As discussed above, in alternate embodiments, the value of the incentive payment is related to the overall transaction volume on the C.U.E. 406 by all users.

Incentive payment 414 may take the form of cash, a credit toward future purchases, additional goods or services, or any other tangible form that provides an economic benefit to the recipient. A discrete amount of equity ownership or other rights to participation 416 in C.U.E. 406, or a business entity promoting the C.U.E. 406, is distributed to the incentive provider's designee—in this case seller's designee 402. In the case of distribution of rights/equity in a business entity, the business entity may take the form of a company that actually maintains and manages the day-to-day operations of the C.U.E., or, alternatively, it could be a company affiliated with, and dependent upon the success of, the C.U.E. The amount of equity or other rights to participation distributed to seller's designee 402 is related to the value of the incentive payment provided to buyer's designee 404.

Reference is now made to FIG. 4B, which is a block diagram illustrating a variation of the incentive mechanism shown in FIG. 4A. In this embodiment, the potential recipient of incentive payment 414—buyer's designee 404—is given the option, to be exercised immediately or over a period of time, of declining incentive payment 414. As shown, when buyer's designee 404 declines incentive payment 414 from seller 402, buyer's designee 404 receives the amount of equity ownership or other rights to participation 416 in C.U.E. 406 that would have been distributed to seller's designee 402 had buyer's designee 404 accepted incentive payment 414 from seller 402. Further, seller 402 may be given the opportunity to purchase equity or rights to participation in the C.U.E. in exchange for paying incentive payment 414 directly to the platform or the business entity that distributes rights to participation in the transaction platform. In this embodiment, both the buyer's designee 402 and the seller 404 are given the option to exchange the incentive payment 414 for rights to participation 416 in the transaction platform 406. In operation, the present incentive mechanism provides an incentive for both buyers and sellers to utilize a transaction platform, resulting in increased transaction efficiency for all industrial participants.

Reference is now made to FIG. 5A which is a block diagram illustrating the operation of an incentive mechanism in another preferred embodiment of the present invention As in FIGS. 4A and 4B, sellers 402 and buyers 404 use a transaction platform 406 to do business, and the value of the transactions executed using the platform is tracked and recorded. In this embodiment, an incentive provider 408 provides an incentive payment 414 to the designee of at least one, and possibly both, of the parties to the transaction. Incentive payment 414 may be proportionate to the value of transactions completed by the transacting parties 402, 404. In exchange for providing incentive payment(s) 414, incentive provider 408, who in this embodiment is not a party to the transaction, or incentive provider's designee (who may be the incentive provider itself) receives an amount of equity ownership or other rights to participation 416 in transaction platform 406.

In a variation of this embodiment, shown in FIG. 5B, the potential recipient(s) of incentive payment(s) 414—seller's designee 402 and/or buyer's designee 404—is given the option, to be exercised immediately or over a period of time, of declining incentive payment(s) 414. As shown, when potential recipients 402, 404 decline incentive payment 414 from incentive provider 408, recipients' designees 402, 404 receive the amount of equity ownership or other rights to participation 416 in transaction platform 406 that would have been distributed to incentive provider's designee 408 had recipients 402, 404 accepted incentive payments 414 Further, incentive provider 408 may be given the opportunity to purchase equity or rights to participation in the transaction platform in exchange for paying incentive payment 414 directly to the platform or the business entity that distributes rights to participation in the transaction platform. In this embodiment, both the designated recipients 402, 404 and incentive provider 408 are given the option to exchange the incentive payment for rights to participation in the transaction platform.

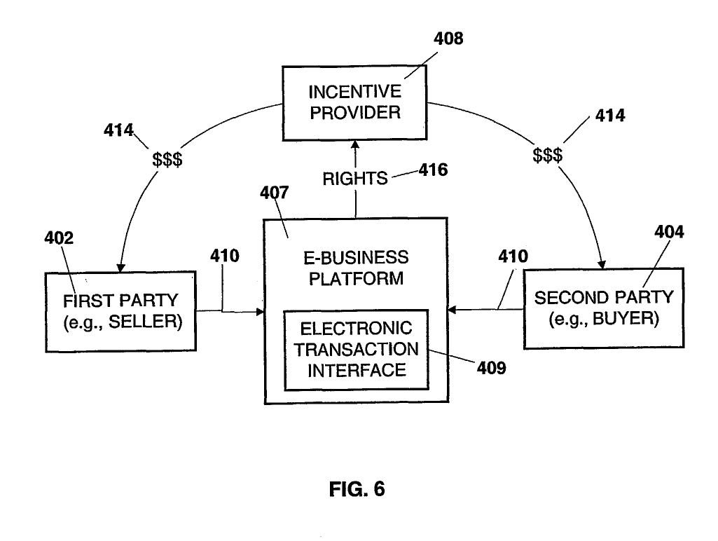

With reference to FIG. 6, and for illustration purposes only, the present invention will be described as it would apply to an e-business platform 407 for use by the food service industry in the United States. As defined above, the term “ebusiness platform” means a communications system, whether distributed or centralized, that is accessible to buyers and sellers and provides a means to communicate and process electronic representations of business information and transactions via computers located with the buyer, seller, or a third party.

The food service industry encompasses the non-retail portion of the food business—all food prepared away from home. The part of the supply chain discussed includes manufacturers (food processors), distributors (food wholesalers), and operators (restaurants, hospitals, etc.). It should be understood, however, that the present invention is applicable to a variety of other transaction platforms and industries with a variety of supply-chain structures. In a preferred embodiment, industry participants, e.g., buyers 404 and sellers 402, access e-business platform 407, having an electronic transaction interface 409, by visiting a web-site accessible via the Internet 410 using a personal computer, handheld device, or other communications tool. In the food service industry, for example, an operator would log on to a web-site and purchase food items from one or more food distributors. The distributors would receive these orders from operators (via email, fax, directly into their computers, or other ways). In this case the measure of use of the platform would be the value of qualified transactions executed. Typically, software running on the web-server tracks the amount of qualified food items purchased by each operator (buyer 404) from each distributor (here, a seller 402). An incentive payment 414 to be paid by an incentive provider 408, who may be the manufacturer of the food items purchased, to either one of or both of the operator 404 or distributor 402 is calculated by the web-server software. In a preferred embodiment, the value of the incentive payment is related (e.g., proportionate) to the value of goods purchased by operator 404 from the distributor 402. Alternatively, the incentive payment may be related to the amount of goods purchased by a distributor from the manufacturer. Incentive payment 414 may take the form of a cash amount, a credit toward future purchase transactions, additional goods, or any other tangible form that provides an economic benefit to the recipient.

In still another variation, the value of incentive payment 414 may be related to an overall measure of utilization of e-business platform 407 throughout the industry, such as the overall transaction volume, or the number of web-site hits, for the given industry as a whole, rather than just the transactions completed between two or three members of the industrial community.

E-business platform 407 may transfer funds or credits directly from the incentive provider's account to the distributor's account, or, in the alternative, incentive provider 408 may arrange for incentive payment 414 to be distributed to the distributor independent of platform 407. In another alternative, incentive provider 408 may pay incentive payment 414 to the operator in addition to, or in lieu of, the payment to the distributor.

As in the previous embodiments, if the incentive provider/manufacturer 408 provides distributor 402 and/or operator 404 with an incentive payment, manufacturer/incentive provider 408 receives an amount of equity or rights to participation 416 in the e-business platform 407 proportionate to the value of incentive payment 414 paid to one or both of distributor 402 and operator 404.

The form of the rights to participation 416 may include equity ownership, such as common stock or any other divisible means of ownership, a preferred stock or credit instrument representing a portion of revenues or profits, or some other financial interest in either the e-business platform 407 or in a business entity that has a financial interest in the e-business platform.

The functionality shown in FIGS. 4B and 5B is also applicable to an e-business platform in the food service industry, since distributors could be given the option to accept the incentive payment or to receive the rights to participation in the transaction platform that would have gone to the manufacturer in exchange for its making the incentive payment. Likewise, if the distributor opts to receive the rights to participation, the manufacturer could be given the option of paying the incentive payment directly to the transaction platform or to a business entity with a financial and/or control interest in the transaction platform in exchange for rights to participation in the transaction platform of equal value.

As a result of this arrangement, distributors are given an incentive to encourage, and even train, operators to utilize the e-business platform for their everyday transactions—the more items ordered by operators via the e-business platform, the more incentive payments a distributor receives Operators have an incentive to participate because of reduced transaction costs and the ability to place orders 24 hours a day. This latter time factor is particularly appropriate for operators in the food service industry because the owners and managers of most restaurants are occupied during normal business hours with other restaurant matters and would be receptive to the ability to place orders for food items during off hours, e.g., late at night. Manufacturers, from the outset, have an incentive to encourage both distributors and operators to participate because the value of the financial interest manufacturers accumulate is directly linked with the success of the platform. Additionally, as the e-business platform becomes the standard platform for distributors and operators, manufacturers will find it very attractive to participate in the platform as well. The platform will likely be the standard platform for the manufacturers' customers, and the manufacturers will have a financial interest in the platform. In this way, this e-business platform will become the standard platform throughout the entire food service industry.

In another embodiment, the present invention relates to a software program implemented on a computer for encouraging the development of a C.U.E. The software program configures the computer to: track the use of the C.U.E.; calculate an incentive payment to be paid to a recipient, the recipient being a designee of a user of the C.U.E.; direct the distribution of the incentive payment from the incentive provider to the recipient; and direct distribution of an amount of equity ownership or other participation in the C.U.E., or any entity with financial and/or control interest in the C.U.E., to the designee of the contributor of the incentive payment, the amount of equity ownership or other participation distributed proportionate to the incentive payment made; whereby both the payer and the recipient are given an incentive to use or encourage use of the C.U.E. As above, the incentive payment may take the form of cash, a credit toward future transactions (e.g., purchases of goods or services), or any other tangible form that provides an economic benefit to the recipient.

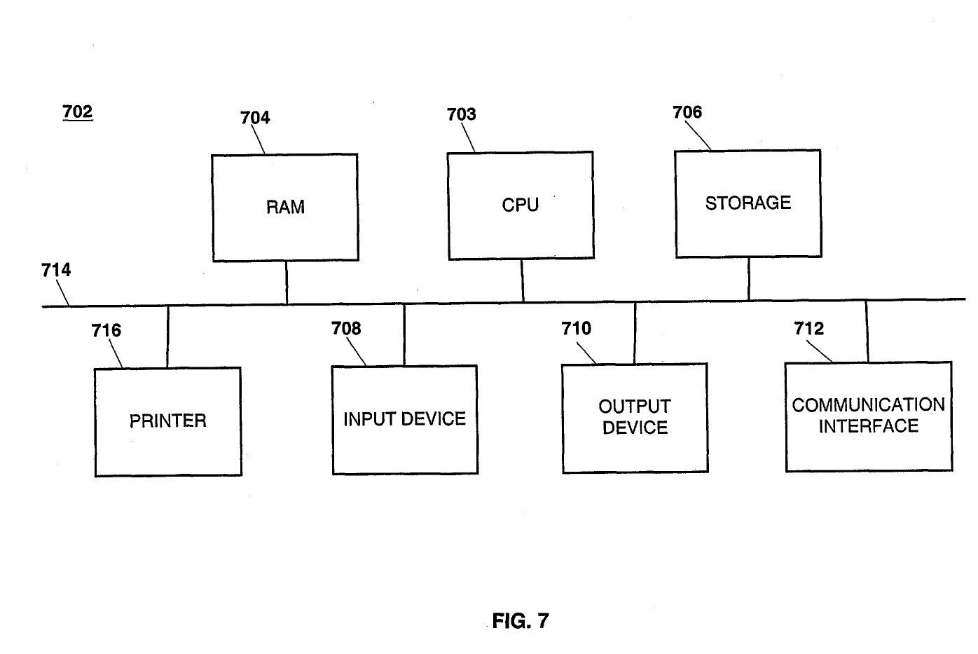

In each of the embodiments discussed above, the present invention may be implemented using a computer system 702 as shown in FIG. 7. This computer includes central processing unit (“CPU”) 703, memory unit 704, one or more storage devices 706, one or more input devices 708, display device 710, and communication interface 712. A system bus 714 is provided for communicating between the above elements. Another output device, such as printer 716, may also be included as part of system 702.

This computer illustratively is an IBM compatible personal computer, but one skilled in the art will understand that the system is not limited to a particular size, class or model of computer. CPU 703 illustratively is one or more microprocessors such as the Pentium™ class of microprocessors available from Intel. Memory unit 704 typically includes both some random access memory (RAM) and some read only memory (ROM).

Input devices 708, which illustratively include a keyboard, a mouse, and/or other similar device, receive data regarding the use of the C.U.E. The inputted usage data is stored in storage device 706. Storage devices 706 illustratively include one or more removable or fixed disk drives, compact discs, DVDs, or tapes. Output device 710 illustratively is a computer display, such as a CRT monitor, LED display or LCD display. Communication interface 712 may be a modem, a network interface, or other connection to external electronic devices, such as a serial or parallel port. For some applications of the invention it is anticipated that this interface will include a connection to the Internet.

Processor 703 calculates an incentive payment using the inputted and stored usage data. Display 710 shows the amount of the incentive payment to be made by an incentive provider to a recipient, the recipient being a designee of a user of the C.U.E. and the amount being related to a measure of the user's use of the C.U.E. Alternatively, the amount of the incentive payment may be related to the total use of the C.U.E. by all users over a period of time. Data recording the payment of incentive payments is entered into computer system 702 via input device 708 and stored in storage device 706. Processor 703 calculates an amount of rights to participation in the C.U.E. to be distributed to a designee of the incentive provider, the amount of rights related to the level of incentive payments made by the incentive provider, and display 710 shows the amount of rights to participation in the C.U.E. to be distributed to the designee of the incentive provider in exchange for the incentive payment.

In an alternative embodiment, input device 708 is used to record whether the recipient accepted the incentive payment, and data recording whether the recipient accepted the incentive payment is stored in storage device 706. If the inputted data indicates that the recipient did not accept the incentive payment, processor 703 calculates an amount of rights to participation in the C.U.E. to be distributed to the recipient, not to the incentive provider, who makes no incentive payment, the amount of rights to participation related to the amount of the incentive payment refused. If the inputted data indicates that the recipient accepted the incentive payment, then processor 703 calculates an amount of rights to participation in the C.U.E. to be distributed to the incentive provider, the amount of rights to participation related to the amount of the incentive payment.

In still another embodiment, if the inputted data indicates that the recipient refused the incentive payment and opted for the rights to participation in the C.U.E., the incentive provider may pay the incentive payment directly to the C.U.E. or a business entity that distributes rights to participation in the C.U.E. Data recording the payment of these incentive payments to the C.U.E. are received via input device 708 and stored on storage device 706. Processor 703 calculates an amount of rights to participation in the C.U.E. to be distributed to the incentive provider, the amount of rights related to the level of the incentive payment.

It should be emphasized that, while the present invention has been discussed in the context of an e-business platform specifically for the food service industry supply chain and the buying and selling of goods among members of that supply chain, the present invention is equally applicable to numerous other C.U.E.'s and transaction platforms, such as retail malls (both real and virtual) and sets of standards and protocols. Furthermore, these entities could serve numerous other industries, regardless of whether those industries have analogous supply chain structures. It should also be understood that while the present invention has been discussed in the context of two-tier and three-tier supply chains, those skilled in the art will recognize that it is equally applicable to supply chains having four or more tiers.

As was mentioned above, those skilled in the art will see that the incentive mechanism can be used in a variety of circumstances, in a variety of industries and corporate or other structures that are not obviously similar to the examples described. The essential elements of the invention that allow parties to exchange incentive payments for rights to participation in a C.U.E. would remain.

Further, while the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the following claims.

What is claimed is:

1. A method for encouraging the development of a communally useful entity comprising the steps of:
a) tracking a measure of use of the communally useful entity;
b) calculating an incentive payment to be paid by an incentive provider to a recipient, the recipient being the designee of a user of the communally useful entity, and the incentive payment proportionate to the measure of the user's use of the communally useful entity;
c) directing the distribution of the incentive payment from the incentive provider to the recipient; and
d) directing the distribution to the incentive provider's designee an amount of rights to participation in the communally useful entity, the amount of rights to participation distributed proportionate to the value of the incentive payment made by the incentive provider
whereby the user is given an immediate incentive to use the communally useful entity, and the incentive provider is given a long-term incentive to encourage others' use of the communally useful entity.

2. The method of claim 1, wherein the user's designee is the user itself.

3. The method of claim 1, wherein the incentive provider's designee is the incentive provider itself.

4. The method of claim 1, wherein the user's designee is a collective entity.

5. The method of claim 1, wherein the incentive provider's designee is a collective entity.

6. The method of claim 1, wherein the communally useful entity is a retail shopping mall.

7. The method of claim 1, wherein the communally useful entity is a distinct set of technological standards.

8. The method of claim 1, wherein the communally useful entity is an e-business platform.

9. The method of claim 8, wherein the e-business platform includes an electronic transaction interface.

10. The method of claim 9, wherein the electronic transaction interface is implemented on a Web site accessible via the Internet.

11. The method of claim 1, wherein the measure of the recipient's use of the communally useful entity is the value of transactions executed by the user using the communally useful entity.

12. The method of claim 1, wherein the amount of rights to participation in the communally useful entity is in the form of equity in a business entity associated with the communally useful entity.

13. The method of claim 1, wherein the incentive payment is also a function of a measure of utilization of the communally useful entity by all users.

14. The method of claim 1, wherein the incentive payment is in the form of cash or a credit toward future transactions.

15. A method for encouraging the adoption and use of a communally useful entity comprising the steps of:
a) tracking a measure of use of the communally useful entity;
b) calculating an incentive payment to be paid by an incentive provider to a recipient, the recipient being the designee of a user of the communally useful entity, and the incentive payment proportionate to the measure of the user's use of the communally useful entity;
c) directing the distribution of the incentive payment from the incentive provider to the recipient; and
d) if the recipient refuses the incentive payment,
directing the distribution to the recipient an amount of rights to participation in the communally useful entity, the amount of rights to participation in the communally useful entity proportionate to the value of the incentive payment refused; but
if the recipient accepts the incentive payment,
directing the distribution to the incentive provider's designee an amount of rights to participation in the communally useful entity, the amount of rights to participation in the communally useful entity distributed in proportion to the value of the incentive payment made by the incentive provider
whereby the user is given an incentive to use the communally useful entity, and the incentive provider is given an incentive to encourage others' use of the communally useful entity.

16. The method of claim 15, further comprising the step of: offering the incentive provider the opportunity to pay the refused incentive payment directly to an entity that distributes the rights to participation in the communally useful entity, in exchange for the incentive provider's designee receiving a proportionate amount of rights to participation in the communally useful entity.

17. The method of claim 15, wherein the user's designee is the user itself.

18. The method of claim 15, wherein the incentive provider's designee is the incentive provider itself.

19. The method of claim 15, wherein the user's designee is a collective entity.

20. The method of claim 15, wherein the incentive provider's designee is a collective entity.

21. The method of claim 15, wherein the communally useful entity is a retail shopping mall.

22. The method of claim 15, wherein the communally useful entity is a distinct set of technological standards.

23. The method of claim 15, wherein the communally useful entity is an e-business platform.

24. The method of claim 23, wherein the e-business platform includes an electronic transaction interface.

25. The method of claim 24, wherein the electronic transaction interface is implemented on a Web site accessible via the Internet.

26. The method of claim 15, wherein the measure of the recipient's use of the communally useful entity is the value of transactions executed by the recipient using the communally useful entity.

27. The method of claim 15, wherein the amount of rights to participation in the communally useful entity is in the form of equity in a business entity associated with the communally useful entity.

28. The method of claim 15, wherein the incentive payment is also a function of a measure of utilization of the communally useful entity by all users.

29. The method of claim 15, wherein the incentive payment is in the form of cash or a credit toward future transactions.

30. A software program implemented on a host computer for encouraging the use of a communally useful entity, the software program configuring the computer to:
a) track a measure of use of the communally useful entity;
b) calculate an incentive payment to be paid by an incentive provider to a recipient, the recipient being the designee of a user of the communally useful entity, and the incentive payment proportionate to a measure of the user's use of the communally useful entity;
c) direct the distribution of the incentive payments from the incentive provider to the recipient;
d) direct the distribution to the incentive provider's designee an amount of rights to participation in the communally useful entity, the amount of rights to participation distributed in proportion to the value of the incentive payment made by the incentive provider;
whereby the user is given an incentive to use the communally useful entity, and the incentive provider is given an incentive to encourage others' use of the communally useful entity.

31. The software program of claim 30, wherein the user's designee is the user itself.

32. The software program of claim 30, wherein the incentive provider's designee is the incentive provider itself.

33. The software program of claim 30, wherein the user's designee is a collective entity.

34. The software program of claim 30, wherein the incentive provider's designee is a collective entity.

35. The software program of claim 30, wherein the communally useful entity is a retail shopping mall.

36. The software program of claim 30, wherein the communally useful entity is a distinct set of technological standards.

37. The software program of claim 30, wherein the communally useful entity is an e-business platform.

38. The software program of claim 37, wherein the e-business platform includes an electronic transaction interface.

39. The software program of claim 38, wherein the electronic transaction interface is implemented on a Web site accessible via the Internet.

40. The software program of claim 30, wherein the measure of the recipient's use of the communally useful entity is the value of transactions executed by the recipient using the communally useful entity.

41. The software program 30, wherein the amount of rights to participation in the communally useful entity is in the form of equity in a business entity associated with the communally useful entity.

42. The software program of claim 30, wherein the incentive payment is also a function of a measure of utilization of the communally useful entity by all users.

43. The software program of claim 30, wherein the incentive payment is in the form of cash or a credit toward future transactions.

44. A software program implemented on a host computer for encouraging the use of a communally useful entity, the software program configuring the computer to:
a) track a measure of use of the communally useful entity,
b) calculate an incentive payment to be paid by an incentive provider to a recipient, the recipient being the designee of a user of the communally useful entity, and the incentive payment proportionate to a measure of the user's use of the communally useful entity,
c) direct the distribution of the incentive payments from the incentive provider to the recipient;
d) if the recipient refuses the incentive payment,
direct the distribution to the recipient an amount of rights to participation in the communally useful entity, the amount of rights to participation in the communally useful entity proportionate to the value of the incentive payment refused; but
if the recipient accepts the incentive payment,
direct the distribution to the incentive provider's designee an amount of rights to participation in the communally useful entity, the amount of rights to participation in the communally useful entity distributed in proportion to the value of the incentive payment made by the incentive provider
whereby the user is given an incentive to use the communally useful entity, and the incentive provider is given an incentive to encourage others' use of the communally useful entity.

45. The software program of claim 44, further configuring the host computer to:
offer the incentive provider the opportunity to pay the refused incentive payment directly to an entity that distributes the rights to participation in the communally useful entity, in exchange for the incentive provider's designee receiving a proportionate amount of rights to participation in the communally useful entity.

46. The software program of claim 44, wherein the user's designee is the user itself.

47. The software program of claim 44, wherein the incentive provider's designee is the incentive provider itself.

48. The software program of claim 44, wherein the user's designee is a collective entity.

49. The software program of claim 44, wherein the user's designee is a collective entity.

50. The software program of claim 44, wherein the communally useful entity is a retail shopping mall.

51. The software program of claim 44, wherein the communally useful entity is a distinct set of technological standards.

52. The software program of claim 44, wherein the communally useful entity is an e-business platform.

53. The software program of claim 52, wherein the e-business platform includes an electronic transaction interface.

54. The software program of claim 53, wherein the electronic transaction interface is implemented on a Web site accessible via the Internet.

55. The software program of claim 44, wherein the measure of the recipient's use of the communally useful entity is the value of transactions executed by the recipient using the communally useful entity.

56. The software program 44, wherein the amount of rights to participation in the communally useful entity is in the form of equity in a business entity associated with the communally useful entity.

57. The software program of claim 44, wherein the incentive payment is also a function of a measure of utilization of the communally useful entity by all users.

58. The software program of claim 44, wherein the incentive payment is in the form of cash or a credit toward future transactions.

59. A computer-based system for encouraging the development of a communally useful entity comprising:
a) a processor;
b) a computer executable routine programming the processor to
track a measure of use of the communally useful entity, calculate an incentive payment to be paid by an incentive provider to a
recipient, the recipient being the designee of a user of the communally useful entity, and the incentive payment proportionate to the measure of the user's user of the communally useful entity,
calculate an amount of rights to participation in the communally useful entity for distribution to the incentive provider's designee, the amount of rights to participation distributed proportionate to the value of the incentive payment made by the incentive provider; and
c) a storage for storing data relating to a measure of use of the communally useful entity by one or more users, incentive payments made by one or more incentive providers, incentive payments received by one or more recipients, and rights to participation distributed to one or more incentive providers' designees
whereby the user is given an immediate incentive to use the communally useful entity, and the incentive provider is given a long-term incentive to encourage others' use of the communally useful entity.

60. The system of claim 59, wherein the communally useful entity is a retail shopping mall.

61. The system of claim 59, wherein the communally useful entity is a distinct set of technological standards.

62. The system of claim 59, wherein the communally useful entity is an e-business platform.

63. The system of claim 62, wherein the e-business platform includes an electronic transaction interface.

64. The system of claim 63, wherein the electronic transaction interface is implemented on a Web site accessible via the Internet.

65. The system of claim 59, wherein the measure of the recipient's use of the communally useful entity is the value of transactions executed by the user using the communally useful entity.

66. The system of claim 59, wherein the amount of rights to participation in the communally useful entity is in the form of equity in a business entity associated with the communally useful entity.

67. The system of claim 59, wherein the incentive payment is also a function of a measure of utilization of the communally useful entity by all users.

68. The system of claim 59, wherein the incentive payment is in the form of cash or a credit toward future transactions.

69. The system of claim 59, wherein the executable routine also programs the processor to track whether the user's designee accepts or declines of the incentive payment.

70. A method for encouraging the development of a business entity comprising the steps of:
a) tracking the use of the business entity;
b) calculating a rebate to be paid by a rebate payer to a recipient, the recipient being the designee of a user of the business entity, and the rebate proportionate to the user's use of the business entity;
c) directing the distribution of the rebate from the rebate payer to the recipient; and
d) directing the distribution to the rebate payer's designee an amount of equity in the business entity, the amount of equity distributed proportionate to the value of the rebate paid by the rebate payer
whereby the user is given an immediate incentive to use the business entity, and the rebate payer is given a long-term incentive to encourage others' use of the business entity.
